(19) United States
(12) Patent Application Publication
(10) Pub. No.: US 2024/0242110 A1
(43) Pub. Date: Jul. 18, 2024

(54) ADAPTIVELY-REPEATED ACTION SELECTION BASED ON A UTILITY GAP

(71) Applicant: International Business Machines Corporation, Armonk, NY (US)

(72) Inventor: RYO IWAKI, Tokyo (JP)

(21) Appl. No.: 18/153,425

(22) Filed: Jan. 12, 2023

(51) Int. Cl. G06N 20/00

(52) U.S. Cl. CPC G06N 20/00

(57) ABSTRACT

A computer-implemented method, a computer program product, and a computer system for adaptively-repeated action selection in reinforcement learning. A computer computes utilities for respective candidate actions at a current time step, using a return distribution predictor. A computer computes a utility gap between a utility of a best action at the current time step and a utility of a reference action. A computer computes a threshold at the current time step for the utility gap. A computer determines whether the utility gap is greater than the threshold. In responding to determining the utility gap being greater than the threshold, a computer accepts the best action at the current time step. In response to determining the utility gap being not greater than the threshold, at the current time step, a computer rejects the best action and repeats an action that has been taken at a previous time step.

### BACKGROUND

The present invention relates generally to reinforcement learning, and more particularly to adaptively-repeated action selection based on a utility gap.

Reinforcement learning (RL) aims at obtaining a good policy that maximizes future return through interactions with the environment. The objective or utility that a user wants to maximize is dependent on either a risk neutral setting of the problem or a risk-sensitive setting of the problem. For example, in the portfolio management problem in a financial market, the objective is not only to maximize the expected return but also to minimize the risk. Some risk measure, instead of expected value, must be used as a utility.

In some applications of RL, frequent changes of actions are not favorable. For example, in the portfolio management problem, frequent changes of the portfolio result in huge amount of transaction cost, which is not favorable.

A study (Lakshminarayanan, et al., Dynamic Action Repetition for Deep Reinforcement Learning, AAAI, 2017) proposes a framework which prepares two sets of action space with different repetition length. If an action is chosen from the first set, it is repeated N₁ times; if an action is chosen from the second set, it is repeated N₂ times. In this framework, the repetition lengths (N₁ and N₂) must be determined in advance.

Another study (Metelli, et al., Control Frequency Adaptation via Action Persistence in Batch Reinforcement Learning, ICML, 2020) uses heuristics to find optimal and static repetition N that maximizes the expected value. All the actions are repeated N times and relies on the Bellman consistency of the risk-neutral value. This study is limited to a risk-neutral setting.

### SUMMARY

In one aspect, a computer-implemented method for adaptively-repeated action selection in reinforcement learning is provided. The computer-implemented method includes computing utilities for respective candidate actions at a current time step, using a return distribution predictor. The computer-implemented method further includes computing a utility gap between a utility of a best action at the current time step and a utility of a reference action. The computer-implemented method further includes computing a threshold at the current time step for the utility gap. The computer-implemented method further includes determining whether the utility gap is greater than the threshold. The computer-implemented method further includes, in responding to determining the utility gap being greater than the threshold, accepting the best action at the current time step. The computer-implemented method further includes, in response to determining the utility gap being not greater than the threshold, at the current time step, rejecting the best action and repeating an action that has been taken at a previous time step.

In another aspect, a computer program product for adaptively-repeated action selection in reinforcement learning is provided. The computer program product comprises a computer readable storage medium having program instructions embodied therewith, and the program instructions are executable by one or more processors. The program instructions are executable to: compute utilities for respective candidate actions at a current time step, using a return distribution predictor; compute a utility gap between a utility of a best action at the current time step and a utility of a reference action; compute a threshold at the current time step for the utility gap; determine whether the utility gap is greater than the threshold; in responding to determining the utility gap being greater than the threshold, accept the best action at the current time step; and in response to determining the utility gap being not greater than the threshold, at the current time step, reject the best action and repeat an action that has been taken at a previous time step.

In yet another aspect, a computer system for adaptively-repeated action selection in reinforcement learning is provided. The computer system comprises one or more processors, one or more computer readable tangible storage devices, and program instructions stored on at least one of the one or more computer readable tangible storage devices for execution by at least one of the one or more processors. The program instructions are executable to compute utilities for respective candidate actions at a current time step, using a return distribution predictor. The program instructions are further executable to compute a utility gap between a utility of a best action at the current time step and a utility of a reference action. The program instructions are further executable to compute a threshold at the current time step for the utility gap. The program instructions are further executable to determine whether the utility gap is greater than the threshold. The program instructions are further executable to, in responding to determining the utility gap being greater than the threshold, accept the best action at the current time step. The program instructions are further executable to, in response to determining the utility gap being not greater than the threshold, at the current time step, reject the best action and repeat an action that has been taken at a previous time step.

### BRIEF DESCRIPTION OF THE SEVERAL VIEWS OF THE DRAWINGS

FIG. 1(A) and FIG. 1(B) illustrate a small utility gap and a large utility gap, in accordance with one embodiment of the present invention.

FIG. 2 presents a graph of utility gaps and thresholds for the utility gaps against time steps, in accordance with one embodiment of the present invention.

FIG. 3 is a flowchart showing a processing flow of reinforcement learning including action selection steps of the present invention, in accordance with one embodiment of the present invention.

FIG. 4 is a flowchart showing operational steps of adaptively-repeated action selection based on a utility gap, in accordance with one embodiment of the present invention.

FIG. 5(A), FIG. 5(B), and FIG. 5(C) show results of an experimental test of adaptively-repeated action selection based on a utility gap, in accordance with one embodiment of the present invention.

FIG. 6 is a systematic diagram illustrating an example of an environment for the execution of at least some of the computer code involved in performing adaptively-repeated action selection based on a utility gap, in accordance with one embodiment of the present invention.

### DETAILED DESCRIPTION

Embodiments of the present invention disclose a method of adaptively-repeated action selection based on a utility gap. With the disclosed method, the action repetition length is adaptively changed without limiting to risk-neutral settings. The disclosed method allows a reinforcement learning (RL) agent to change an action only when the action has a large impact in terms of the utility.

The utility is an abstraction or a proxy for an objective which are aimed at maximizing or minimizing. In a risk-neutral setting, the utility is an expected value of the future return to be maximized. In a more complicated setting (such as a risk-sensitive setting), the utility is a proxy for the return and/or the risk. The utility must be chosen carefully by a user so that values of the objective improve. In an example of a portfolio management problem (which will be described in detail in later paragraphs), the return will be maximized and the risk will be minimized simultaneously. In the example of a portfolio management problem, the entropic risk measure is chosen as the utility and an RL agent maximizes the entropic risk measure as the proxy value.

The disclosed method uses RL for sequential decision making. In the disclosed method, an action chosen by the RL agent is accepted only when the difference or gap between the utility of a best action and the utility of a reference action (e.g., a second-best action) is above a threshold. When the difference or gap is not above the threshold, the action is not accepted and an action in a previous decision or a previous time step is repeated. The reference action and the threshold, or the procedures of adaptively determining the reference action and the threshold, are predefined in advance or predetermined. The disclosed method is not limited to the risk-neutral value maximization, but also applicable to risk-sensitive setting.

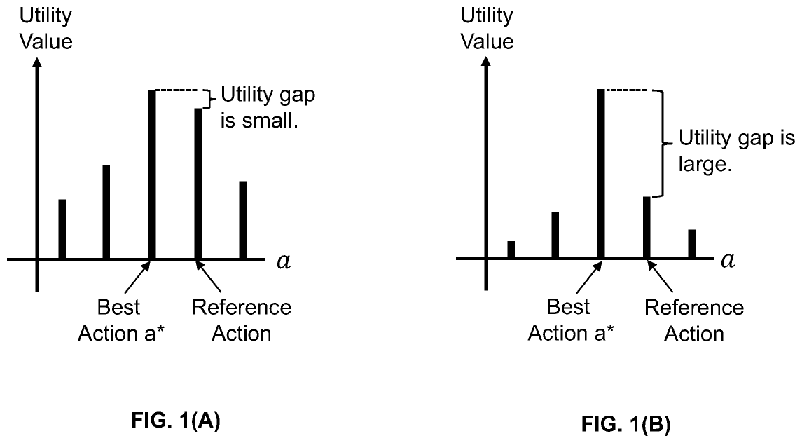

FIG. 1(A) illustrates a small utility gap between a best action a* and a reference action (e.g., a second-best action). FIG. 1(B) illustrates a large utility gap between a best action a* and a reference action (e.g., a second-best action). For the small utility gap shown in FIG. 1(A), the best action a* has similar impact compared to the reference action and other actions. For the large utility gap shown in FIG. 1(B), the best action a* has large impact compared to the reference action and other actions.

In one embodiment of the present invention, to reduce the instability due to the frequent action changes, the action chosen at time step t is accepted only when the utility gap between the utility of the best action at time step t and the utility at time step t of an action that has been taken at a previous time step (t−1) is above a threshold (which is possibly time-dependent). When the utility gap between the utility of the best action at time step t and the utility at time step t of the action taken at the previous time step is not above a threshold, the action that has been taken at the previous time step t−1 is repeated at time step t.

In one embodiment of the present invention, a p-th percentile of the utility gap in last N time steps is adopted as a value of the adaptive threshold. A value of p and a value of N are predetermined.

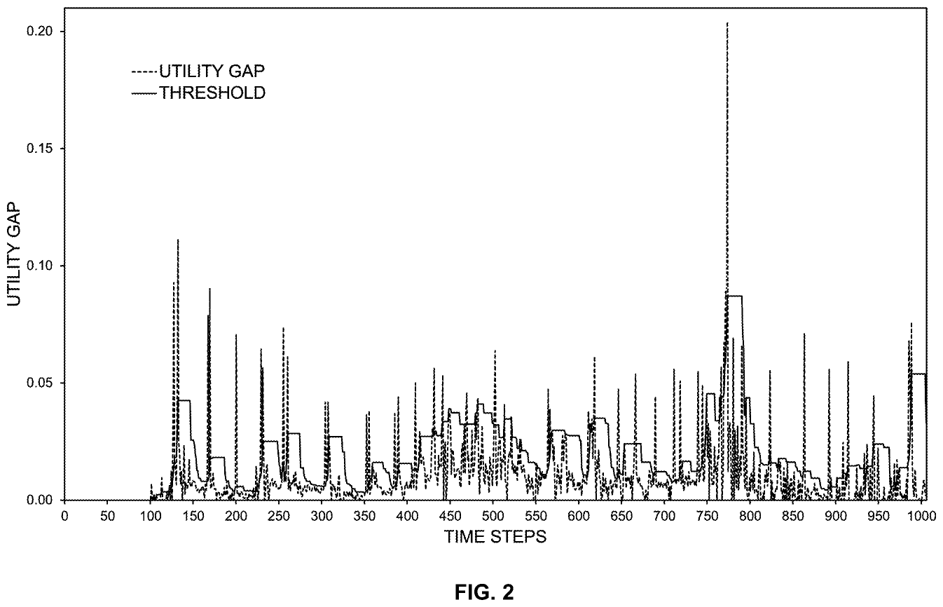

In an example shown in FIG. 2, values of utility gaps at different time steps are presented by dashed line segments, and values of the threshold for the utility gaps at different time steps are presented by solid line segments. If a utility value (which is on the dashed line segments) at time step tis higher than a threshold value (which is on the solid line segments) at time step t, an action chosen (or the best action) at time step t is accepted; otherwise, an action chosen at time step t is not accepted and an action that has been taken at time step t−1 is repeated at time step t.

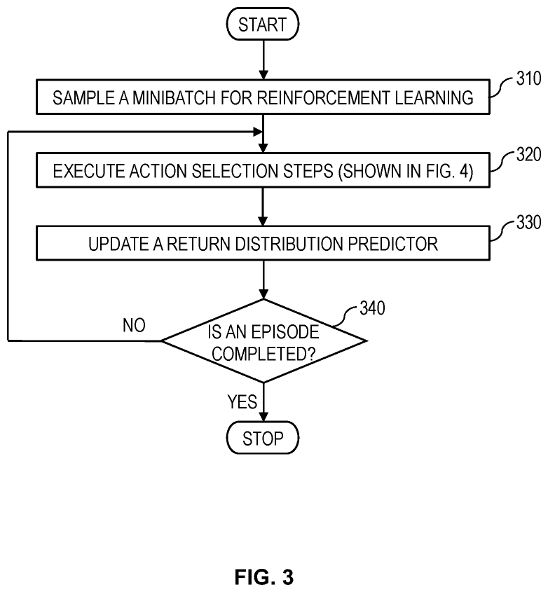

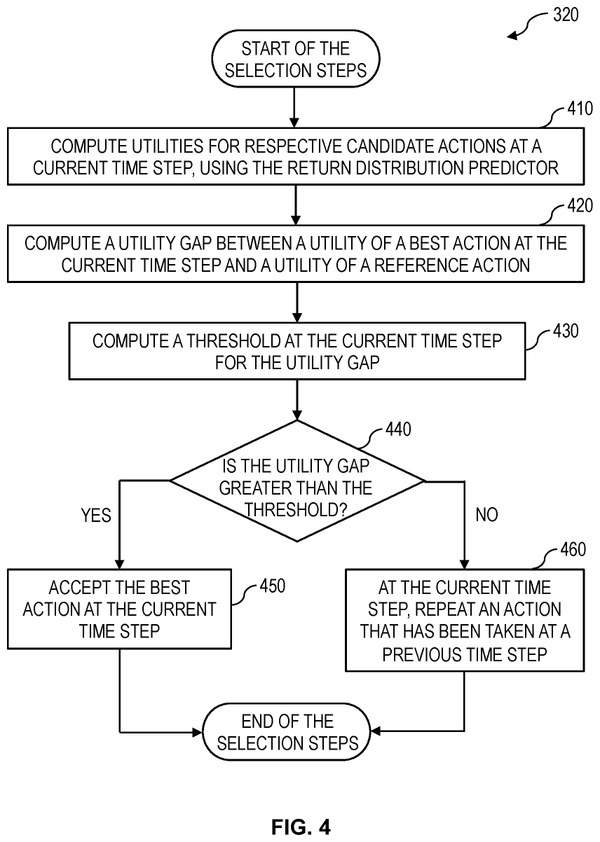

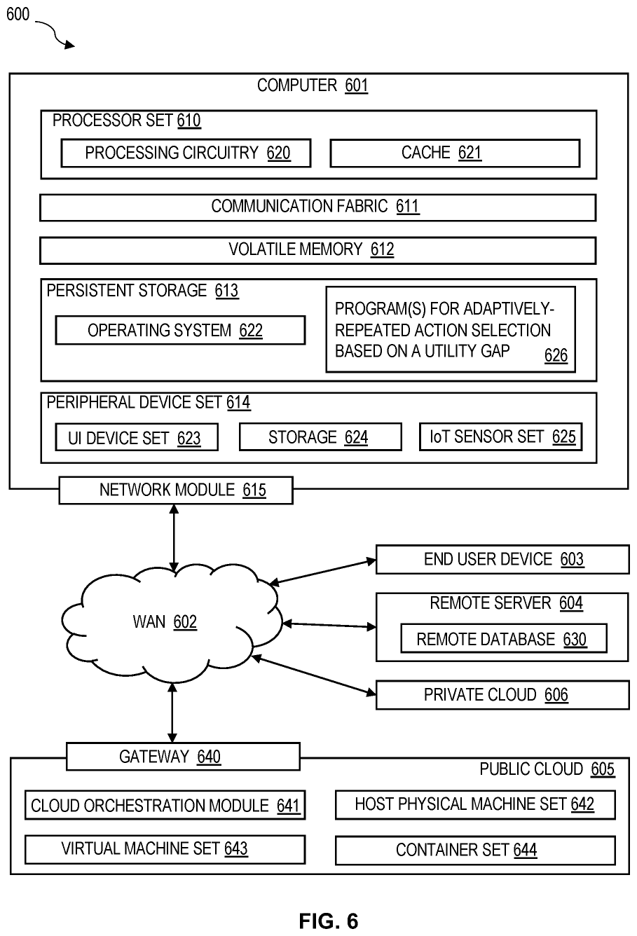

FIG. 3 is a flowchart showing a processing flow of reinforcement learning including action selection steps of the present invention, in accordance with one embodiment of the present invention. The steps of the processing flow of reinforcement learning are implemented by a computer or server (such as computer 601 in FIG. 6). In step 310, the computer or server samples a minibatch for reinforcement learning (RL). In step 320, the computer or server executes action selection steps. The action selection steps will be described in detail in later paragraphs with reference to FIG. 4.

In step 330, the computer or server updates a return distribution predictor. The present invention is used in a distributional RL method. In a distributional RL setting, an RL agent learns a predictor of the probability distribution of the return (a cumulative sum of future rewards) conditioned on a state-action pair. For example, the predictor is a neural network (NN) whose input is a state and outputs are the predicted return distributions associated with action candidates.

In step 340, the computer or server determines whether an episode of the RL is completed. In response to determining the episode of the RL being not completed (NO branch of decision block 340), the computer or server iterates steps 320 and 330. In response to determining the episode of the RL being completed (YES branch of decision block 340), the computer or server ends the processing flow of reinforcement learning.

FIG. 4 is a flowchart showing operational steps of adaptively-repeated action selection based on a utility gap, in accordance with one embodiment of the present invention. In FIG. 4, step 320 (executing action selection steps) shown in FIG. 3 is described in detail. The steps shown in FIG. 4 are implemented by a computer or server (such as computer 601 in FIG. 6).

Upon the start of the action selection steps, the computer or server, in step 410, computes utilities for respective candidate actions at a current time step, using the return distribution predictor.

In step 420, the computer or server computes a utility gap between a utility of a best action at the current time step and a utility of a reference action. As shown in FIG. 1(A) and FIG. 1(B), the utility gap is the difference between the best action a* and the reference action. In one embodiment of the present invention, the utility gap is the difference between a utility of the best action at time step t and a utility at time step t of an action that has been taken at previous time step t−1 (where the action that has been taken at time step t−1 is as the reference action).

In step 430, the computer or server computes a threshold at the current time step for the utility gap. In one embodiment of the present invention, a p-th percentile of the utility gaps in last N time steps before the current time step t is adopted as the threshold value, where p and N values are predetermined.

In step 440, the computer or server determines whether the utility gap is greater than the threshold. In response to determining the utility gap being greater than the threshold (YES branch of decision block 440), at step 450, the computer or server accepts the best action at the current time step. When the utility gap is greater than the threshold, the best action at the current time step has a large impact on the utility and therefore the RL agent changes an action at the current time by accepting the best action.

In response to determining the utility gap being not greater than the threshold (NO branch of decision block 440), at step 460, the computer or server, at the current time step, repeats an action that has been taken at a previous time step. When the utility gap is not greater than the threshold, the best action at the current time step has a small impact on the utility. Therefore, the computer or server does not accept the best action at the current time step and repeats the action that has been taken at the previous time step (t−1).

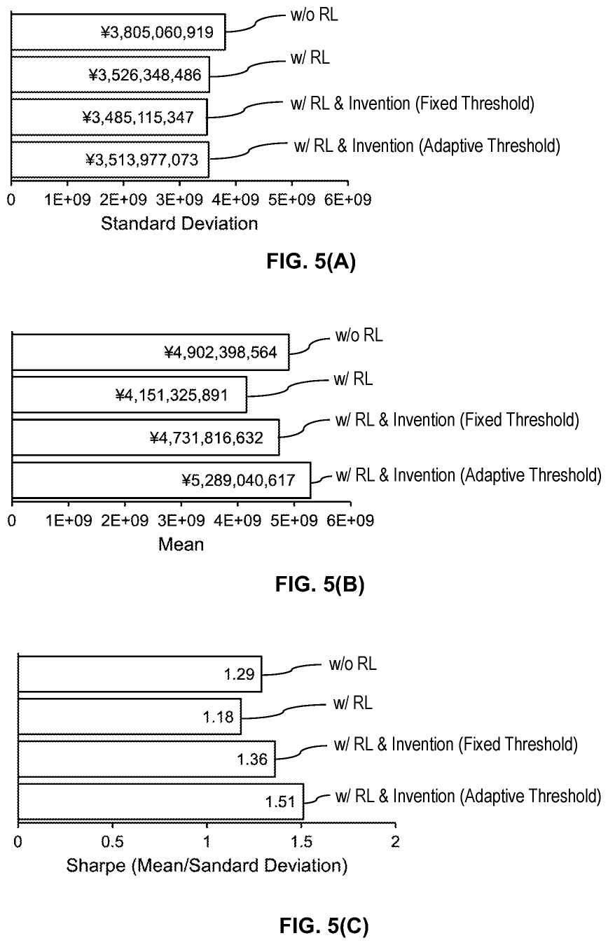

FIG. 5(A), FIG. 5(B), and FIG. 5(C) show results of an experimental test of adaptively-repeated action selection based on a utility gap, in accordance with one embodiment of the present invention. The disclosed method of the present invention was tested for a portfolio management problem. The object of the experimental test was to manage a portfolio to reduce the risk and improve the efficiency by controlling the total volume of the portfolio using reinforcement learning. In the experimental test, the disclosed method was used in distributional reinforcement learning. In the experimental test, the entropic risk measure was as the utility.

FIG. 5(A) presents values of standard deviations of returns for four test cases: without RL, with RL, with RL and the disclosed method of the present invention which is with a fixed threshold, with RL and the disclosed method of the present invention which is with adaptive thresholds. A smaller standard deviation value indicates a better result. FIG. 5(B) presents values of means of returns for the four test cases. A large mean value indicates a better result. FIG. 5(C) presents values of Sharp ratios of returns for the four test cases. A Sharpe ratio is a ratio of a mean to a standard deviation. A large Sharpe ratio value indicates a better result.

As shown in FIG. 5(A), FIG. 5(B), and FIG. 5(C), without the disclosed method of the present invention, although an RL agent can reduce the risk (the standard deviation of the return), the efficiency (the mean of the return and the Sharpe ratio) decreases due to the huge transaction cost incurred by too many trades.

Furthermore, as shown in FIG. 5(A), FIG. 5(B), and FIG. 5(C), the disclosed method of the present invention, an RL agent successfully reduces the risk and improve the efficiency simultaneously.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

In FIG. 6, computing environment 600 contains an example of an environment for the execution of at least some of the computer code involved in performing the inventive methods, such as program(s) 626 for performing adaptively-repeated action selection based on a utility gap. In addition to block 626, computing environment 600 includes, for example, computer 601, wide area network (WAN) 602, end user device (EUD) 603, remote server 604, public cloud 605, and private cloud 606. In this embodiment, computer 601 includes processor set 610 (including processing circuitry 620 and cache 621), communication fabric 611, volatile memory 612, persistent storage 613 (including operating system 622 and block 626, as identified above), peripheral device set 614 (including user interface (UI) device set 623, storage 624, and Internet of Things (IoT) sensor set 625), and network module 615. Remote server 604 includes remote database 630. Public cloud 605 includes gateway 640, cloud orchestration module 641, host physical machine set 642, virtual machine set 643, and container set 644.

Computer 601 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 630. As is well understood in the art of computer technology, and depending upon the technology, performance of a computer-implemented method may be distributed among multiple computers and/or between multiple locations. On the other hand, in this presentation of computing environment 600, detailed discussion is focused on a single computer, specifically computer 601, to keep the presentation as simple as possible. Computer 601 may be located in a cloud, even though it is not shown in a cloud in FIG. 6. On the other hand, computer 601 is not required to be in a cloud except to any extent as may be affirmatively indicated.

Processor set 610 includes one, or more, computer processors of any type now known or to be developed in the future. Processing circuitry 620 may be distributed over multiple packages, for example, multiple, coordinated integrated circuit chips. Processing circuitry 620 may implement multiple processor threads and/or multiple processor cores. Cache 621 is memory that is located in the processor chip package(s) and is typically used for data or code that should be available for rapid access by the threads or cores running on processor set 610. Cache memories are typically organized into multiple levels depending upon relative proximity to the processing circuitry. Alternatively, some, or all, of the cache for the processor set may be located “off chip.” In some computing environments, processor set 610 may be designed for working with qubits and performing quantum computing.

Computer readable program instructions are typically loaded onto computer 601 to cause a series of operational steps to be performed by processor set 610 of computer 601 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 621 and the other storage media discussed below. The program instructions, and associated data, are accessed by processor set 610 to control and direct performance of the inventive methods. In computing environment 600, at least some of the instructions for performing the inventive methods may be stored in block 626 in persistent storage 613.

Communication fabric 611 is the signal conduction paths that allow the various components of computer 601 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 612 is any type of volatile memory now known or to be developed in the future. Examples include dynamic type random access memory (RAM) or static type RAM. Typically, the volatile memory is characterized by random access, but this is not required unless affirmatively indicated. In computer 601, the volatile memory 612 is located in a single package and is internal to computer 601, but, alternatively or additionally, the volatile memory may be distributed over multiple packages and/or located externally with respect to computer 601.

Persistent storage 613 is any form of non-volatile storage for computers that is now known or to be developed in the future. The non-volatility of this storage means that the stored data is maintained regardless of whether power is being supplied to computer 601 and/or directly to persistent storage 613. Persistent storage 613 may be a read only memory (ROM), but typically at least a portion of the persistent storage allows writing of data, deletion of data and re-writing of data. Some familiar forms of persistent storage include magnetic disks and solid state storage devices. Operating system 622 may take several forms, such as various known proprietary operating systems or open source Portable Operating System Interface type operating systems that employ a kernel. The code included in block 626 typically includes at least some of the computer code involved in performing the inventive methods.

Peripheral device set 614 includes the set of peripheral devices of computer 601. Data communication connections between the peripheral devices and the other components of computer 601 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 623 may include components such as a display screen, speaker, microphone, wearable devices (such as goggles and smart watches), keyboard, mouse, printer, touchpad, game controllers, and haptic devices. Storage 624 is external storage, such as an external hard drive, or insertable storage, such as an SD card. Storage 624 may be persistent and/or volatile. In some embodiments, storage 624 may take the form of a quantum computing storage device for storing data in the form of qubits. In embodiments where computer 601 is required to have a large amount of storage (for example, where computer 601 locally stores and manages a large database) then this storage may be provided by peripheral storage devices designed for storing very large amounts of data, such as a storage area network (SAN) that is shared by multiple, geographically distributed computers. IoT sensor set 625 is made up of sensors that can be used in Internet of Things applications. For example, one sensor may be a thermometer and another sensor may be a motion detector.

Network module 615 is the collection of computer software, hardware, and firmware that allows computer 601 to communicate with other computers through WAN 602. Network module 615 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 615 are performed on the same physical hardware device. In other embodiments (for example, embodiments that utilize software-defined networking (SDN)), the control functions and the forwarding functions of network module 615 are performed on physically separate devices, such that the control functions manage several different network hardware devices. Computer readable program instructions for performing the inventive methods can typically be downloaded to computer 601 from an external computer or external storage device through a network adapter card or network interface included in network module 615.

WAN 602 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 603 is any computer system that is used and controlled by an end user (for example, a customer of an enterprise that operates computer 601), and may take any of the forms discussed above in connection with computer 601. EUD 603 typically receives helpful and useful data from the operations of computer 601. For example, in a hypothetical case where computer 601 is designed to provide a recommendation to an end user, this recommendation would typically be communicated from network module 615 of computer 601 through WAN 602 to EUD 603. In this way, EUD 603 can display, or otherwise present, the recommendation to an end user. In some embodiments, EUD 603 may be a client device, such as thin client, heavy client, mainframe computer, desktop computer and so on.

Remote server 604 is any computer system that serves at least some data and/or functionality to computer 601. Remote server 604 may be controlled and used by the same entity that operates computer 601. Remote server 604 represents the machine(s) that collect and store helpful and useful data for use by other computers, such as computer 601. For example, in a hypothetical case where computer 601 is designed and programmed to provide a recommendation based on historical data, then this historical data may be provided to computer 601 from remote database 630 of remote server 604.

Public cloud 605 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 605 is performed by the computer hardware and/or software of cloud orchestration module 641. The computing resources provided by public cloud 605 are typically implemented by virtual computing environments that run on various computers making up the computers of host physical machine set 642, which is the universe of physical computers in and/or available to public cloud 605. The virtual computing environments (VCEs) typically take the form of virtual machines from virtual machine set 643 and/or containers from container set 644. It is understood that these VCEs may be stored as images and may be transferred among and between the various physical machine hosts, either as images or after instantiation of the VCE. Cloud orchestration module 641 manages the transfer and storage of images, deploys new instantiations of VCEs and manages active instantiations of VCE deployments. Gateway 640 is the collection of computer software, hardware, and firmware that allows public cloud 605 to communicate through WAN 602.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 606 is similar to public cloud 605, except that the computing resources are only available for use by a single enterprise. While private cloud 606 is depicted as being in communication with WAN 602, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 605 and private cloud 606 are both part of a larger hybrid cloud.

What is claimed is:

1. A computer-implemented method for adaptively-repeated action selection in reinforcement learning, the method comprising:
computing utilities for respective candidate actions at a current time step, using a return distribution predictor;
computing a utility gap between a utility of a best action at the current time step and a utility of a reference action;
computing a threshold at the current time step for the utility gap;
determining whether the utility gap is greater than the threshold;
in responding to determining the utility gap being greater than the threshold, accepting the best action at the current time step; and
in response to determining the utility gap being not greater than the threshold, at the current time step, rejecting the best action and repeating an action that has been taken at a previous time step.

2. The computer-implemented method of claim 1, wherein the utility of the reference action is an utility at current time step of the action that has been taken at the previous time step.

3. The computer-implemented method of claim 1, wherein a p-th percentile of utility gaps in last N time steps before the current time step is adopted as the threshold.

4. The computer-implemented method of claim 3, wherein a value of p and a value of N are predetermined.

5. The computer-implemented method of claim 1, further comprising:
after the adaptively-repeated action selection, updating the return distribution predictor.

6. The computer-implemented method of claim 1, wherein the best action has a greater impact than the reference action when the utility gap is greater than the threshold, wherein the best action has a similar impact as the reference action when the utility gap is not greater than the threshold.

7. A computer program product for adaptively-repeated action selection in reinforcement learning, the computer program product comprising a computer readable storage medium having program instructions embodied therewith, the program instructions executable by one or more processors, the program instructions executable to:
compute utilities for respective candidate actions at a current time step, using a return distribution predictor;
compute a utility gap between a utility of a best action at the current time step and a utility of a reference action;
compute a threshold at the current time step for the utility gap;
determine whether the utility gap is greater than the threshold;
in responding to determining the utility gap being greater than the threshold, accept the best action at the current time step; and
in response to determining the utility gap being not greater than the threshold, at the current time step, reject the best action and repeat an action that has been taken at a previous time step.

8. The computer program product of claim 7, wherein the utility of the reference action is an utility at current time step of the action that has been taken at the previous time step.

9. The computer program product of claim 7, wherein a p-th percentile of utility gaps in last N time steps before the current time step is adopted as the threshold.

10. The computer program product of claim 9, wherein a value of p and a value of N are predetermined.

11. The computer program product of claim 7, further comprising program instructions executable to:
after the adaptively-repeated action selection, update the return distribution predictor.

12. The computer program product of claim 7, wherein the best action has a greater impact than the reference action when the utility gap is greater than the threshold, wherein the best action has a similar impact as the reference action when the utility gap is not greater than the threshold.

13. A computer system for adaptively-repeated action selection in reinforcement learning, the computer system comprising one or more processors, one or more computer readable tangible storage devices, and program instructions stored on at least one of the one or more computer readable tangible storage devices for execution by at least one of the one or more processors, the program instructions executable to:
compute utilities for respective candidate actions at a current time step, using a return distribution predictor;
compute a utility gap between a utility of a best action at the current time step and a utility of a reference action;
compute a threshold at the current time step for the utility gap;
determine whether the utility gap is greater than the threshold;
in responding to determining the utility gap being greater than the threshold, accept the best action at the current time step; and
in response to determining the utility gap being not greater than the threshold, at the current time step, reject the best action and repeat an action that has been taken at a previous time step.

14. The computer system of claim 13, wherein the utility of the reference action is an utility at current time step of the action that has been taken at the previous time step.

15. The computer system of claim 13, wherein a p-th percentile of utility gaps in last N time steps before the current time step is adopted as the threshold.

16. The computer system of claim 15, wherein a value of p and a value of N are predetermined.

17. The computer system of claim 13, further comprising program instructions executable to:
after the adaptively-repeated action selection, update the return distribution predictor.

18. The computer system of claim 13, wherein the best action has a greater impact than the reference action when the utility gap is greater than the threshold, wherein the best action has a similar impact as the reference action when the utility gap is not greater than the threshold.
